(19) United States
(12) Patent Application Publication
(10) Pub. No.: US 2026/0119087 A1
(43) Pub. Date: Apr. 30, 2026

(54) CONTROL METHOD AND NON-TRANSITORY COMPUTER READABLE STORAGE MEDIUM

(71) Applicant: BROTHER KOGYO KABUSHIKI KAISHA, Nagoya (JP)

(72) Inventor: Junjiro Yoshida, Nagoya (JP)

(21) Appl. No.: 19/277,343

(22) Filed: Jul. 22, 2025

(30) Foreign Application Priority Data
Oct. 28, 2024 (JP) 2024-188960

(51) Int. Cl. G06F 3/12

(52) U.S. Cl. CPC G06F 3/1204; G06F 3/1208; G06F 3/1243; G06F 3/1252; G06F 3/1256

(57) ABSTRACT

A non-transitory computer readable storage medium storing a program executable by an information processing apparatus connected to a label printer and having a label editing function, the program causing the apparatus to execute: a display process; a designation process; an object selection process; a first column selection process; and a second column selection process. In response to receiving a first print instruction, for each row constituting a database designated by the designation process, the program further causes the apparatus to execute a generation process of generating label data obtained by writing text indicated in data in a first column to a first text object, and a first printing process of causing the label printer to perform printing based on a label data for a number of copies indicated in data in a second column.

### REFERENCE TO RELATED APPLICATIONS

This application claims priority from Japanese Patent Applications No. 2024-188960 filed on Oct. 28, 2024. The entire contents of the priority application are incorporated herein by reference.

### BACKGROUND ART

In a related art, a configuration is known in which a printing condition is written in a database in a table format consisting of rows and columns, and a label is printed by a label printer using the database. For example, a configuration is known in which a database in which a layout number and the number of print targets to be issued can be designated in predetermined columns is prepared, and a label printing apparatus prints a label according to a record corresponding to a row of the database.

In the configuration disclosed in the above related art, the configuration of the database is determined in advance, and for example, there is no description of freely determining a cell for designating the number of labels to be issued corresponding to the layout number, that is, the number of copies to be printed, and the degree of freedom in designing the database is low.

### SUMMARY

A non-transitory computer readable storage medium storing a program for solving the above-described problems is a program executable by an information processing apparatus connected to a label printer and having a label editing function, the program causing the information processing apparatus to execute: a display process of displaying, on a user interface of the information processing apparatus, an editing screen that receives editing of a label and on which at least one text object is able to be disposed; a designation process of designating a database in a table format consisting of rows and columns; an object selection process of selecting, as a first text object, one of the text objects disposed on the editing screen; a first column selection process of selecting, as a first column, one of the columns constituting the database designated in the designation process; and a second column selection process of selecting, as a second column, one of the columns constituting the database designated in the designation process and different from the first column, in which in response to receiving a first print instruction, for each row constituting the database designated by the designation process, the program further causes the information processing apparatus to execute a generation process of generating label data obtained by writing text indicated in data in the first column selected in the first column selection process to the first text object selected in the object selection process, and a first printing process of causing the label printer to perform printing based on the label data generated in the generation process for the number of copies indicated in data in the second column selected in the second column selection process.

### BRIEF DESCRIPTION OF DRAWINGS

FIG. 1 is a schematic configuration diagram of a printing system.

FIG. 2 is a sequence diagram for illustrating a procedure of a label creation process.

FIG. 3 is a diagram illustrating an example of a label editing screen.

FIG. 4 is a diagram illustrating an example of a database designation screen.

FIG. 5 is a diagram illustrating an example of the label editing screen.

FIG. 6 is a diagram illustrating an example of a print setting screen when a second method is selected.

FIG. 7 is a flowchart illustrating an example of a control procedure of a print data generation process.

FIG. 8 is a flowchart illustrating an example of a control procedure of a number-of-copies determination process.

FIG. 9 is a diagram illustrating an example of the print setting screen when a first method and a column indicating the number of copies are selected.

FIG. 10 is a diagram illustrating an example of the print setting screen when the first method and a column indicating an item other than the number of copies are selected.

FIG. 11 is a diagram illustrating an example of the print setting screen when the first method and a column other than the number of copies are selected and all rows are designated.

### DESCRIPTION

Hereinafter, an embodiment embodying a program will be described in detail with reference to the accompanying drawings. The present specification discloses the program executed by an information processing apparatus connectable to a label printer.

### Schematic Configuration of PC

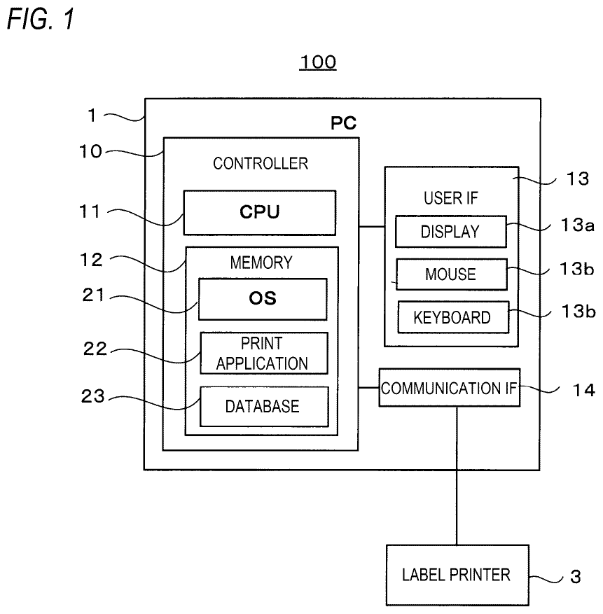

A printing system 100 according to the present embodiment includes a personal computer (hereinafter, referred to as “PC”) 1 and a label printer 3, and the PC 1 and the label printer 3 are communicably connected to each other. The PC 1 includes a controller 10 including a CPU 11 and a memory 12 as illustrated in FIG. 1. The PC 1 is an example of the “information processing apparatus”. The CPU 11 is an example of the computer. The PC 1 includes a user interface (hereinafter, referred to as a “user IF”) 13, and a communication interface (hereinafter, referred to as a “communication IF”) 14 that are electrically connected to the controller 10. The controller 10 in FIG. 1 is a collective term for hardware and software used to control the PC 1, and does not necessarily represent a single piece of hardware actually present in the PC 1. An example of the “information processing apparatus” is not limited to the PC 1, and may be a smartphone or a tablet terminal.

The CPU 11 executes various processes according to a program read from the memory 12 and based on a user's operation. The memory 12 stores various programs including an operating system (hereinafter, referred to as “OS”) 21 and a print application program (hereinafter, referred to as “print application”) 22, and various types of data including a database 23. The memory 12 is used as a work area in a case where various processes are executed.

The CPU 11 may read the print application 22 from a storage medium readable by the CPU 11. Examples of the storage medium readable by the CPU 11 include a CD-ROM, a DVD-ROM, and a USB memory.

The user IF 13 includes hardware that displays a screen for notifying a user of information, and hardware that receives an operation by the user. The user IF 13 of the present embodiment is a combination of a display 13a capable of displaying information and a mouse 13b and a keyboard 13c having an input receiving function. The user IF 13 may be a touch panel having a display function and the input receiving function.

The communication IF 14 includes hardware for communicating with an external apparatus such as the label printer 3. Communication standards of the communication IF 14 include Ethernet (registered trademark), Wi-Fi (registered trademark), USB, and the like. The PC 1 may include a plurality of communication IFs 14 corresponding to the plurality of communication standards.

The OS 21 stored in the memory 12 of the PC 1, for example, iOS (registered trademark), Android (registered trademark), Windows (registered trademark), macOS (registered trademark), Linux (registered trademark).

The print application 22 is, for example, a program having a function of receiving a user instruction via the user IF 13 and causing the PC 1 to edit an image to be printed and transmit a print instruction to the label printer 3 based on the received instruction. The print application 22 is an example of the “program”.

The database 23 is a tabular database consisting of rows and columns, and is a database in which a plurality of pieces of data are stored. The database 23 is a file created by the user, and is not stored in the memory 12 at the time of factory shipment of the PC 1. A plurality of databases 23 may be stored in the memory 12. Details of the print application 22 and the database 23 will be described later.

### Schematic Configuration of Label Printer 3

The label printer 3 of the present embodiment has at least a printing function and a communication function. A printing method of the label printer 3 is, for example, a thermal transfer method, an inkjet method, or an electrophotographic method. When receiving the print instruction and label data to be printed from an external apparatus such as the PC 1 via the communication function, the label printer 3 executes printing based on the label data to create a label.

The label printer 3 can accommodate, for example, roll-shaped label paper, and has a function of printing an image on the label paper to create a label. The roll-shaped label paper is a printing medium in a state in which the label paper is superimposed and wound on a continuous strip-shaped release paper. The label paper may be a continuous long tape, or may be a die-cut label cut into a predetermined shape in advance. The label printer 3 of the present embodiment may have a function of cutting and discharging a printed portion after printing

### Outline of Database Printing

The print application 22 according to the present embodiment can execute database printing based on a database file including text data. In the database printing, the print application 22 receives designation of a database to be printed, designation of a row to be printed in the designated database, designation of a text object to be disposed in the label data, designation of a column to be associated with the text object (hereinafter, referred to as a “first column”) in columns constituting the database, and designation of a column indicating the number of copies (hereinafter, referred to as a “second column”) in columns constituting the database.

When the print application 22 receives an execution instruction of the database printing, the print application 22 creates label data in which the text data in the first column provided in the designated database is written to the text object associated with the first column for each row designated as a print target, and causes the label printer 3 to execute printing based on the created label data. The print application 22 creates label data in which the designated text data in the first column is written to a text object, for the number of copies indicated in the designated data in the second column, and passes the label data to the label printer 3. Accordingly, the print application 22 can cause the label printer 3 to create a plurality of labels on which the text data stored in any column of the database is printed based on the number of copies determined in the this column.

### Label Creation Procedure

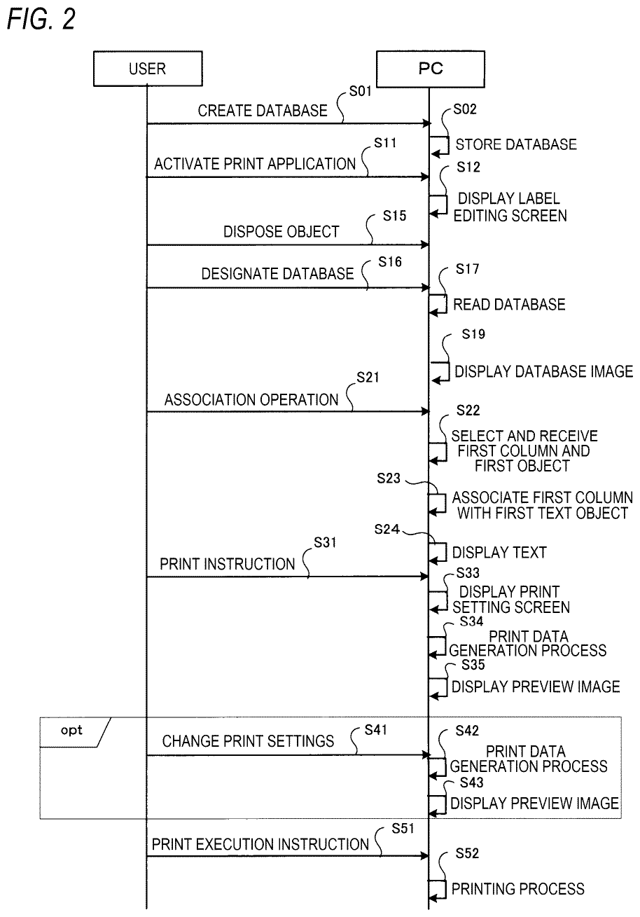

Next, a procedure for creating a label using the database printing will be described with reference to a sequence diagram of FIG. 2. Procedures and processing steps of each program described below basically indicate a process of the CPU 11 according to commands described in each program. That is, the processes such as “judgment”, “determination”, “acquisition”, and “reception” to be described below represent the processes of the CPU 11. The processes by the CPU 11 also include hardware control using an API of the OS 21. In the present specification, the description of the OS 21 is omitted, and an operation of each program is described. The term “acquisition” is used as a concept indicating that a request is not essential.

### Creation of Database

The user who wants to create a label creates the database 23 that stores data to be printed (S01), and stores the database 23 in the PC 1 (S02). The database 23 includes, for example, a file in a comma-separated values (CSV) format or a file in an Excel (registered trademark) format. That is, the database 23 of the present embodiment is a so-called relational database or a database similar thereto, and includes tables in a tabular format. The user may create the database 23 using an application program for table creation or the like, or may create the database 23 as a text file in which pieces of text indicating data are arranged. The user may create the database 23 in the PC 1 or may store a database created in another apparatus in the PC 1.

### Label Editing Process

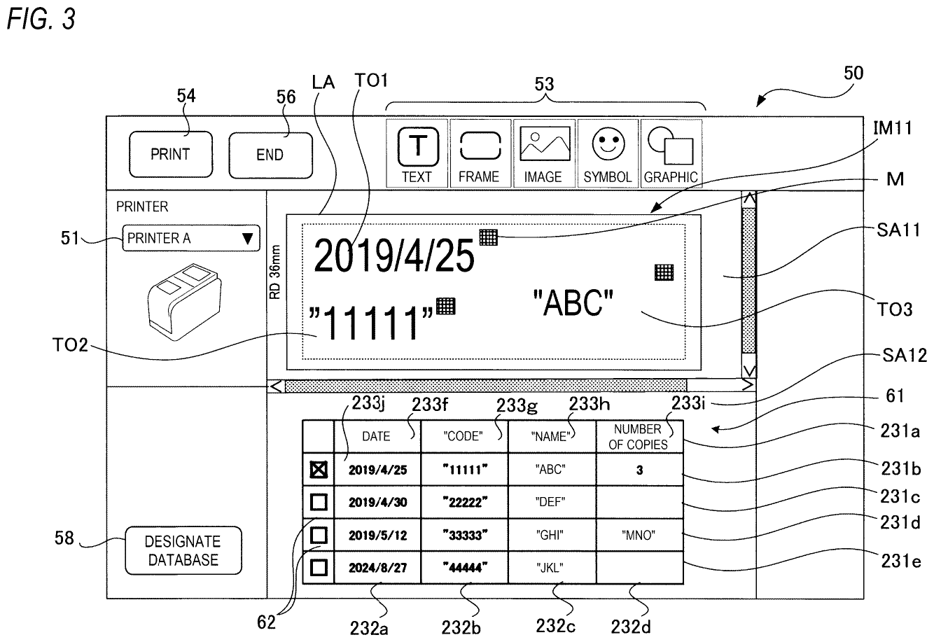

As illustrated in FIG. 2, the user who performs the database printing inputs an activation instruction of the print application 22 in the PC 1 (S11). When the print application 22 is activated, for example, as illustrated in FIG. 3, a label editing screen 50 for receiving an instruction to create a label is displayed on the display 13a of the user IF 13 (S12). The label editing screen 50 is an example of an “editing screen”. S12 is an example of a “display process” and a “display step”. Then, the PC 1 can receive a user's operation on the label editing screen 50 being displayed.

For example, as illustrated in FIG. 3, the label editing screen 50 is a screen including a printer selection field 51, a label display region SA11, and buttons for receiving various instructions. The label display region SA11 is a region for displaying a printing image IM11 of a label to be printed. The end button 56 is a button for receiving an instruction to end the print application 22. The print button 54 is a button for receiving an instruction to execute printing. The button 58 is a button for receiving selection of a database used for database printing. The button 58 is a button for receiving an instruction to designate a file storing a database to be printed from files stored in the PC 1. In FIG. 3, a database display region (hereinafter, referred to as “DB display region”) SA12 displayed below the label display region SA11 is displayed when the button 58 is operated to designate a database, and is not displayed when the button 58 is not operated.

The user generates label data of a label to be printed on the label editing screen 50. Therefore, the user disposes the objects in a label region LA showing the label on the label editing screen 50 so as to form the configuration of the label the user wants to create (S15). The print application 22 includes a plurality of types of objects such as text, marks, and photographs as the objects that can be arranged in the label display region SA11. The user who wants to create a label can dispose a text object in the label region LA by operating a text object selection button among an object selection button group 53 using the mouse 13b. The text object is an object in which text is written in the designated area. The user determines the number of objects to be printed on one label and disposes the objects in the label region LA.

When the text object is disposed in the label region LA, the print application 22 displays the button 58 on the label editing screen 50.

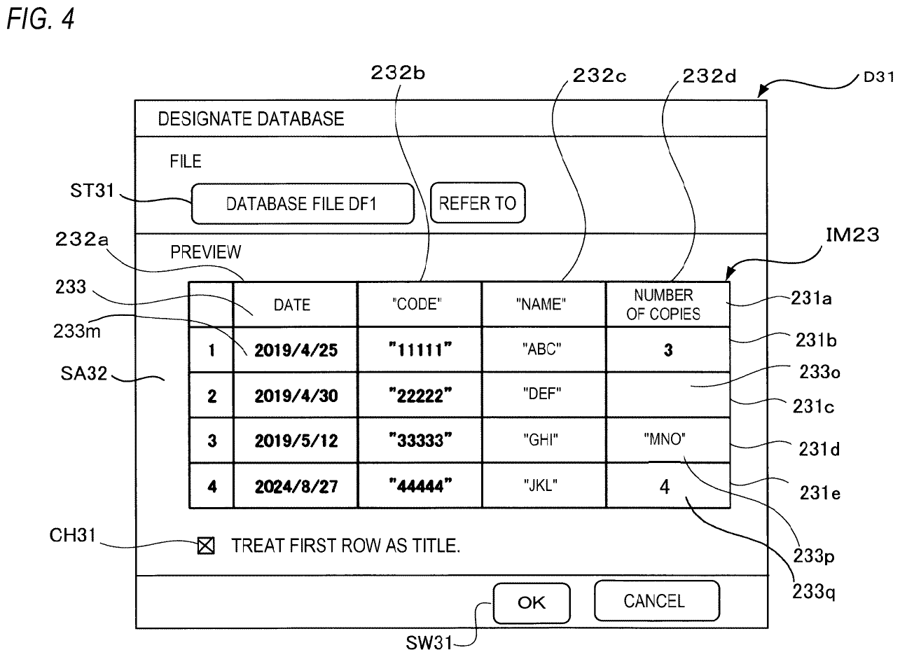

As illustrated in FIG. 2, the user operates the button 58 to designate the database 23 (S16). S16 is an example of a “designation process” and a “designation step”. When the button 58 is operated, the print application 22 displays, for example, a database designation screen D31 illustrated in FIG. 4 on the display 13a of the user IF 13. The database designation screen D31 includes a designation field ST31 designating a database in a file format supported by the print application 22, and a database display field SA32 displaying an image of the database designated in the designation field ST31. The database designation screen D31 illustrated in FIG. 4 shows a state in which the image IM23 of the database 23 is displayed. On the database designation screen D31, a check box CH31 for determining whether to treat data in each column of the first row as a title of each column is displayed below the picture image IM23. FIG. 4 illustrates a case where the check box CH31 is checked.

As illustrated in the image IM23 of FIG. 4, the database 23 includes a plurality of rows and a plurality of columns. The first row is a row in which the titles of one or more items are associated. In the present embodiment, the first row includes items of “date”, “code”, “name”, and “number of copies”. The second and subsequent rows are associated with data for each item. A grid indicated by a row and column is generally called a cell. The database 23 of the present embodiment includes a plurality of cells 233. Note that, in the present embodiment, each grid in which the row and column intersect, including the first row, is regarded as the cell 233. Characters can be input to each of the plurality of cells 233. A blank cell 233 may also be present. In the present embodiment, for example, a cell 2330 in the fourth column is blank. In the cell 233, characters invalid for the items in the first row may be input. In the present embodiment, for example, invalid characters are input to the cell 233p in the fourth column. The invalid characters are, for example, non-numerical data “MNO”. The invalid characters are not limited to the non-numerical data, and may be a numerical value exceeding an upper limit number of printed sheets of a label printer to be controlled or a negative number. FIG. 4 illustrates an example in which characters valid for the titles are input to all the cells 233 except for the fourth column.

The database designation screen D31 includes an OK button SW31 for confirming the designation of the database. The print application 22 receives the designation of the database input in the designation field ST31 and the determination of how to treat the first row in response to the operation of the OK button SW31. The process of setting the data in each column of the first row as the title of each column via the check box CH31 is an example of a “determination process” and a “determination step”.

As illustrated in FIG. 2, when the database 23 is designated, the print application 22 reads the designated database 23 from the memory 12 (S17), and displays a database image 61 indicating contents of the designated database 23 in the DB display region SA12 of the label editing screen 50 (S19). FIG. 3 illustrates an example in which the database 23 designated in FIG. 4 is read, and items in the first row are determined as titles of each column. In the database image 61, a check box 62 for selecting a print target is provided for each row, except for the first row that is determined to be treated as titles.

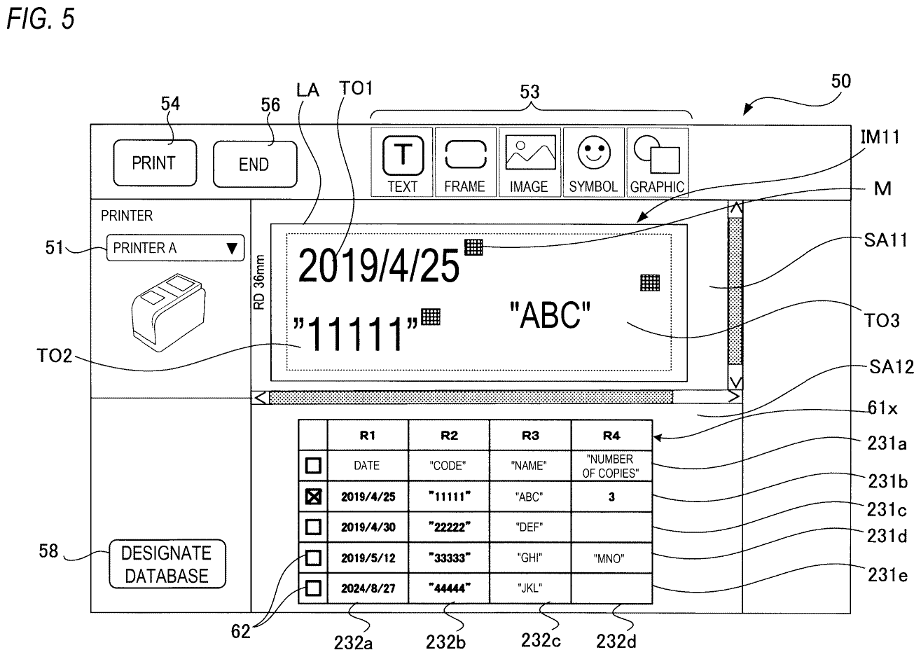

When the check box CH31 is not checked and the data in each column of the first row is not treated as the title of each column, the print application 22 displays a database image 61x illustrated in FIG. 5 in the DB display region SA12. The database image 61x is different from the database image 61 of FIG. 3, which is displayed when the data in each column of the first row is determined as the title of each column, in that the data in each column provided in the database 23 is displayed in correspondence with items “R1”, “R2”, “R3”, and “R4” that distinguish the columns and the check box 62 is also displayed in the first row.

The user performs an association operation via the label editing screen 50 (S21). The association operation is an operation of associating the designated column of the database with the text object. The print application 22 according to the present embodiment receives the association operation by a drag and drop operation (hereinafter, referred to as a “D&D operation”) in which one of the titles provided in the database image 61 is dragged and dropped onto the text object disposed in the label region LA. The association operation may be an operation different from the D&D operation, such as a flip operation.

The print application 22 selects the column of the dragged title as a first column, and selects the dropped text object as a first text object (S22). S22 is an example of an “object selection process”, a “first column selection process”, an “object selection step”, and a “first column selection step”. The print application 22 associates the first column selected in S22 with the first text object selected in S22 (S23), and displays one of the data provided in the first column in the first text object (S24). In the present embodiment, data in a row closest to the head among the rows selected as print targets is displayed.

For example, as illustrated in FIG. 3, it is assumed that the user places three text objects TO1, TO2, and TO3 in the label region LA. The user uses the mouse 13b to drag a cell 233f indicating the title “date” and drop it onto the text object TO1. The print application 22 selects the column 232a as the first column and the text object TO1 as the first text object, and associates them. The print application 22 writes and displays, in the text object TO1, “Apr. 25, 2019” indicated in a cell 233j of a selected row 231b. At this time, the print application 22 may display, in the text object TO1, a mark M indicating that the text object has been associated. The mark M is displayed on the label editing screen 50, but is not included in the label data and is not printed on the label.

Similarly, the print application 22 associates a column 232b with the text object TO2 and a column 232c with the text object TO3 in response to the D&D operation. The text objects TO1, TO2, and TO3 are examples of the “first text object”. The columns 232a, 232b, and 232c are examples of the “first column”. Therefore, the print application 22 can easily associate the text object disposed in the label data with the column provided in the database 23 by the D&D operation.

The column for which the association is completed may be excluded from targets of the D&D operation and may be excluded from selection targets of the first column. For example, when the title of the column showing only numerical data is selected as the first column by the D&D operation, the print application 22 may display a warning on the display 13a.

### Print Setting Process

As illustrated in FIG. 2, when the user operates the print button 54 on the label editing screen 50, the print application 22 receives the print instruction (S31). The print instruction of S31 is an example of a “first print instruction” and a “second print instruction”. The print application 22 that has received the print instruction displays a print setting screen (S33).

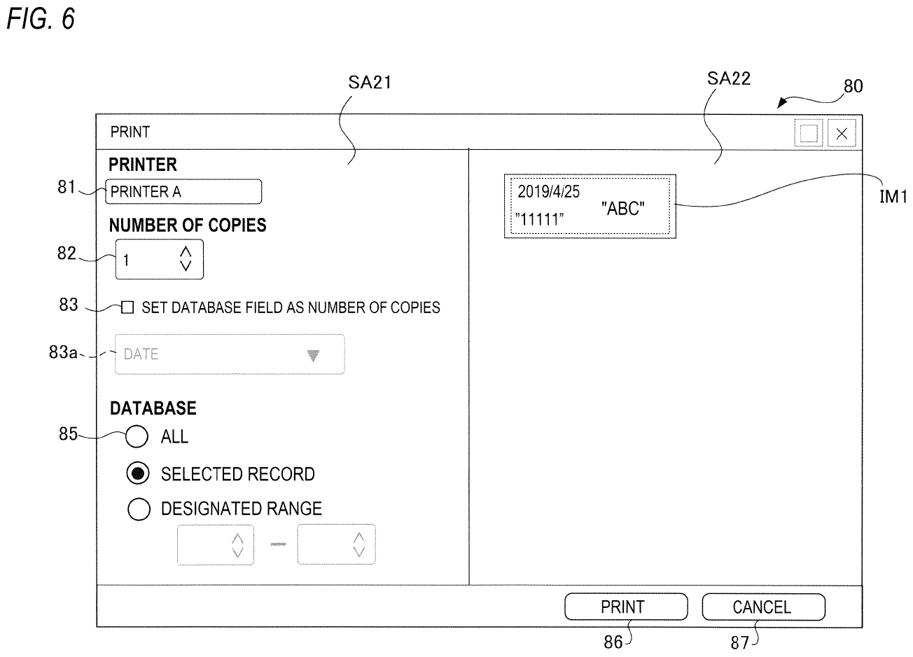

For example, a print setting screen 80 illustrated in FIG. 6 includes a print setting region SA21, a print button 86, and a cancel button 87. The print setting region SA21 is a region for receiving various print settings. The print setting region SA21 includes, for example, a printer selection field 81, and can receive setting or change of a printer to be controlled.

In the print setting region SA21, designation of the number of copies can be received. In the present embodiment, a number-of-copies designation method includes a first method of setting the number of copies for each print target based on the database and a second method of collectively setting the number of copies for all print targets. In the print setting region SA21 of the present embodiment, the selection of the first method and the second method is exclusively controlled.

That is, the print setting region SA21 includes a number-of-copies setting field 82 that receives the number of copies of the label to be printed by the second method. In the number-of-copies setting field 82, a negative number, a value equal to or greater than a predetermined value (a value outside a setting range as the number of copies), and data other than a numerical value may be prohibited from being input. The number-of-copies setting field 82 is an example of a “number-of-copies object”.

The print setting region SA21 includes a number-of-copies designation method selection field 83 for switching between the first method and the second method. The print setting region SA21 includes a column selection field 83a that receives selection of a column indicating the number of copies. The print application 22 can designate a column indicating the number of copies by the column selection field 83a. When there is a setting in which data in each column of the first row is treated as the title of each column via the check box CH31, the column selection field 83a can display a list of data “date”, “code”, “name”, and “number of copies” indicated by each item in the first row. On the other hand, when there is a setting in which the data in each column of the first row is not treated as the title of each column via the check box CH31, the column selection field 83a can display a list of items “R1”, “R2”, “R3”, and “R4” (see FIG. 5) for distinguishing the columns instead of the titles. Therefore, by displaying the titles shown in the first row of the database 23 in a list in the column selection field 83a, even if the data content of each column differs depending on the database, the user can easily understand the data content of each column and the column indicating the number of copies. Since the title of the number of copies is not displayed in the column selection field 83a, the user can easily understand that the number of copies is not set for each row of the database 23. An initial value of the column selection field 83a may be determined in advance or may be a display of an item selected at the time of previous database printing.

The number-of-copies designation method selection field 83 of the present embodiment is a check box for selecting the first method, disabling the number-of-copies setting field 82, and operably displaying the column selection field 83a when there is a check, and selecting the second method, operably displaying the number-of-copies setting field 82, and disabling the column selection field 83a when there is no check. Examples of a method of disabling the number-of-copies setting field 82 and the column selection field 83a include graying out, hiding, and not receiving an operation.

The print setting region SA21 includes a print target designation field 85 for designating a row to be printed. In the print target designation field 85 of the present embodiment, “all”, “selected record”, and “range designation” can be alternatively selected. “All” receives an instruction to print all the rows of the designated database 23. The “selected record” receives an instruction to set the row selected by the check box 62 provided in the database image 61 of the label editing screen 50 as a print target. The “range designation” receives an instruction to set a row in a range designated by the user as the print target. The number of rows selected by the “selected record” or the “range designation” may be one or more.

The print setting region SA21 can receive settings for items other than the number of copies and the print target, such as label size, character color, and print density.

The print application 22 executes a print data generation process based on the label data edited on the label editing screen 50 and initial values of the print setting screen 80 (S34). The print data generation process is a process of generating print data. The print data generation process will be described later. After executing the print data generation process, the print application 22 displays a preview image IM1 showing a printing image of a label in a preview image display region SA22 of the print setting screen 80 (S35). The print setting screen 80 is an example of a “preview screen”. The preview image IM1 may be displayed on a screen different from the print setting screen 80.

When the user changes print settings via the print setting screen 80 (S41), the print application 22 executes the print data generation process based on the changed print settings (S42). That is, the print application 22 generates print data reflecting the change of the print setting. The print application 22 displays the preview image IM1 reflecting the change of the print settings in the preview image display region SA22 based on the generated print data. The print data generation process of S34 is the same as the print data generation process of S32. The process of displaying the preview image in S43 is the same as the process in S35. The process of S35 and S43 is an example of a “preview process” and a “preview step”. The process of generating the print data will be described later.

### Printing Process

When the user operates the print button 86 on the print setting screen 80, the print application 22 receives a print execution instruction as illustrated in FIG. 2 (S51). The print application 22 outputs the print data generated in the print data generation process to the label printer 3 to be controlled, and causes the label printer 3 to print the label (S52).

When the number-of-copies designation method received via the print setting screen 80 is the first method, the print application 22 transmits the print data to the label printer 3 for the number of copies indicated by the data in the column designated in the column selection field 83a for each row designated in the print target designation field 85, and causes the label printer 3 to print the label. In this case, a different number of labels created for each row can be created depending on the number of copies set for each row. On the other hand, when the number-of-copies designation method is the second method, the print application 22 transmits the print data to the label printer 3 for the number of copies set in the number-of-copies setting field 82 for each row designated in the print target designation field 85, and causes the label printer 3 to print the label. In this case, the same number of labels are created for each row. The process of S52 when the first method is designated is an example of the “first printing process” and a “first printing step”. The process of S52 when the second method is designated is an example of the “second printing process” and a “second printing step”.

### Print Data Generation Process

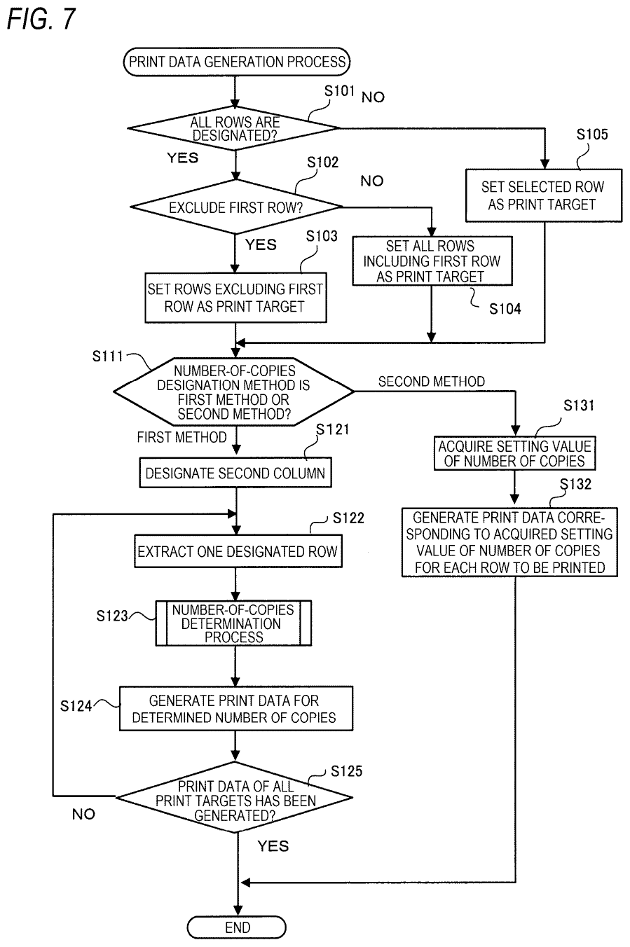

The print data generation process described above will be described with reference to FIG. 7. The CPU 11 of the PC 1 executes the print data generation process as a process by the print application 22. First, the CPU 11 determines whether all the rows are designated (S101).

When “all” is set in the print target designation field 85 of the print setting screen 80, the CPU 11 determines that all the rows are designated. If all the rows are designated (S101: YES), the CPU 11 determines whether to exclude the first row from the print target (S102). When the check box CH31 is checked at the time of database designation, the CPU 11 determines to exclude the first row from the print target. If the first row is to be excluded from the print target (S102: YES), the CPU 11 sets the rows from the second row to the last row of the designated database 23 as the print target (S103), and the process proceeds to S111. On the other hand, when the check box CH31 is not checked at the time of database designation, the CPU 11 determines not to exclude the first row from the print target. If the first row is not excluded from the print target (S102: NO), the CPU 11 sets all the rows including the first row of the designated database 23 as the print target (S104), and the process proceeds to S111.

On the other hand, when the “selected record” or the “range designation” is set in the print target designation field 85 of the print setting screen 80, the CPU 11 determines that the designation of the row is not all the rows since the row is selected. If not all the rows are designated (S101: NO), the CPU 11 sets the selected row as the print target (S105), and the process proceeds to S111. For example, after receiving the print instruction in a state in which the row 231b is designated via the check box 62 of the database image 61 on the label editing screen 50 illustrated in FIG. 3, the CPU 11 sets the row 231b as the print target when “selected record” is set in the print target designation field 85 of the print setting screen 80 as illustrated in FIG. 6. Further, for example, when the “range designation” is set in the print target designation field 85 of the print setting screen 80 and the range is set to the third and fourth rows, the CPU 11 sets rows 231d and 231e of the database 23 as the print target. The process of designating rows via the print target designation field 85 is an example of a “row setting process” and a “row setting step”.

The CPU 11 that has set the print target determines whether the number-of-copies designation method is the first method or the second method (S111). When the number-of-copies designation method selection field 83 of the print setting screen 80 is not checked, the CPU 11 determines that the number-of-copies designation method is the second method (S111: second method), and the process proceeds to S131. On the other hand, when the number-of-copies designation method selection field 83 of the print setting screen 80 is checked, the CPU 11 determines that the number-of-copies designation method is the first method (S111: first method), and the process proceeds to S121. The process of setting the first method or the second method via the number-of-copies designation method selection field 83 is an example of a “method setting process” and a “method setting step”.

When the number-of-copies designation method is the second method (S111: second method), the CPU 11 acquires a setting value of the number of copies set in the number-of-copies setting field 82 (S131). The process of setting the number of copies via the number-of-copies setting field 82 is an example of a “number-of-copies setting process” and a “number-of-copies setting step”. The CPU 11 generates print data corresponding to the setting value of the number of copies acquired in S131 for each row to be printed (S132). S132 is an example of a “generation process” and a “generation step”.

For example, it is assumed that the user operates the print button 54 in a state in which the row 231b is selected via the check box 62 on the label editing screen 50, and selects the second method as the number-of-copies designation method on the print setting screen 80 as illustrated in FIG. 6. In this case, the CPU 11 writes data in the first column to the first text object for each row to be printed and generates label data. For example, when the columns 232a, 232b, and 232c of the database 23 are associated with the text objects TO1, TO2, and TO3, respectively, the CPU 11 writes the data “Apr. 25, 2019”, “11111”, and “ABC” indicated in the columns 232a, 232b, and 232c of the row 231b to the text objects TO1, TO2, and TO3, respectively, and generates label data for the row 231b. The CPU 11 renders the label data to generate print data. The CPU 11 generates one piece of print data based on the number of copies “1” set in the number-of-copies setting field 82.

When the number of copies set in the number-of-copies setting field 82 is two or more, the CPU 11 copies and creates the print data according to the number of copies. When there are a plurality of print targets, the CPU 11 creates print data in each row of the print targets for the number of copies set in the number-of-copies setting field 82.

When the number of copies is designated by the second method and the print data for the number of copies set in the number-of-copies setting field 82 is generated for each designated row, the CPU 11 ends the print data generation process. The CPU 11 displays the preview image of the label in the preview image display region SA22 of the print setting screen 80 for each row based on the print data (S35 and S43 of FIG. 2). That is, when the second method is selected and data printing is performed, the number of print data created for each row and the number of preview images displayed for each row are the same. Since the number of copies in each row is common, the preview image corresponding to each row may be displayed one by one.

Therefore, if the number of copies is the same for all the rows, selecting the second method and database printing is expected to reduce time and effort of the user, as it is not necessary to write the number of copies in every row when creating the database.

On the other hand, the CPU 11 that has determined that the number-of-copies designation method is the first method designates the second column (S121). That is, the CPU 11 designates the column set in the column selection field 83a of the print setting screen 80 as the second column. The process of setting the second column in the column selection field 83a is an example of a “second column selection process” and a “second column selection step”.

The CPU 11 extracts one designated row (S122) and executes a number-of-copies determination process (S123). The number-of-copies determination process is a process for determining the number of copies for each row to be printed based on the data indicated in the second column designated in step S121. The print application 22 may not be able to determine what data is in which column in the database created by the user. Therefore, the CPU 11 allows the user to select a column indicating the number of copies, and determines the number of copies based on data in the selected column. The number-of-copies determination process will be described later.

After determining the number of copies, the CPU 11 generates print data for the number of copies determined in S123 based on the data in the row extracted in S122 (S124). That is, the CPU 11 generates print data of the same content for the number of copies determined in S123. The method of generating the print data is the same as that in step S132, and a description thereof will be omitted. S124 is an example of a “generation process” and a “generation step”.

After generating the print data for the extracted row, the CPU 11 determines whether the print data for all the print targets has been generated (S125). When a plurality of rows are designated and there is a row for which print data has not been generated, it is determined that print data of all the print targets has not been generated (S125: NO), the process returns to S122, and the CPU 11 extracts the next row and generates the print data. On the other hand, when the print data has been generated for all the designated rows, it is determined that the print data of all the print targets has been generated (S125: YES), and the CPU 11 ends the print data generation process. The CPU 11 displays the preview image of each label for the number of copies determined in S123 (S35 and S42 of FIG. 2). That is, when the first method is selected and data printing is performed, the number of print data created for each row and the number of preview images displayed for each row may differ depending on the row.

### Number-of-Copies Determination Process

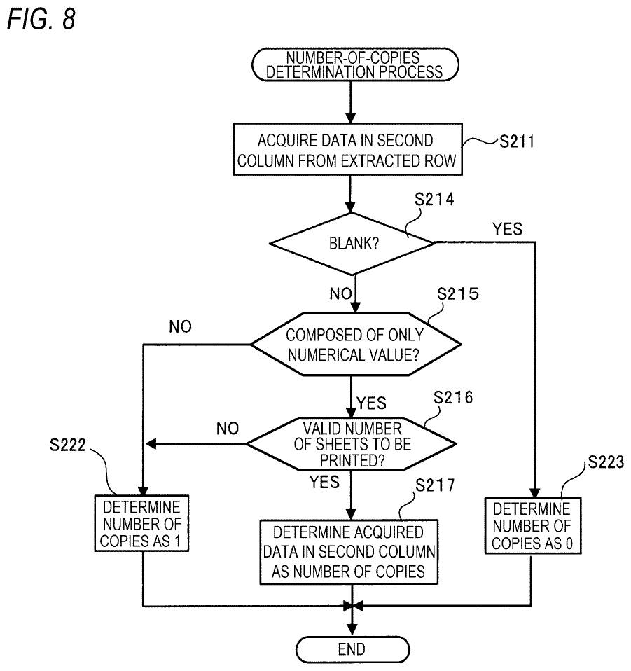

The number-of-copies determination process described above will be described with reference to FIG. 8. The CPU 11 acquires data in the column selected as the second column in S121 from the row extracted in S122 of FIG. 7 (S211).

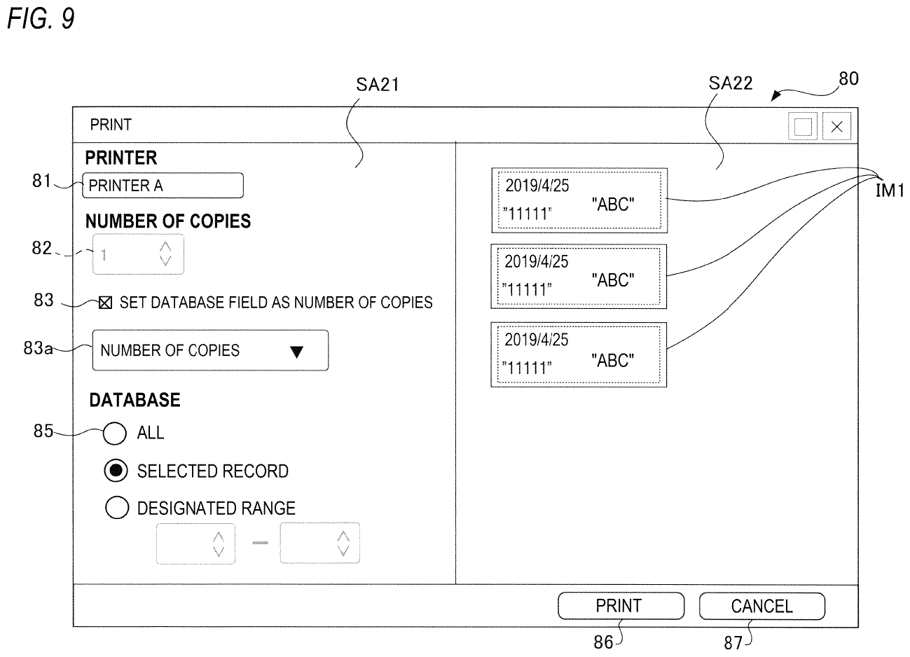

In the print setting screen 80 illustrated in FIG. 9, the number-of-copies designation method selection field 83 is checked, and the number-of-copies designation method is set to the first method. In the column selection field 83a, a column of a title of “number of copies” is selected. Further, a state in which “selected record” is set in the print target designation field 85 is illustrated. Here, it is assumed that only the row 231b of the database 23 is selected as the print target.

In the case of the print setting illustrated in FIG. 9, the CPU 11 acquires the data “3” indicated in a column 232d (cell 233n) indicating the “number of copies” among the data provided in the row 231b of the database 23 illustrated in FIG. 4. In this case, as illustrated in FIG. 8, since there is data in the cell 233n, the CPU 11 determines that the cell 233n is not blank (S214: NO). Since the acquired data is “3” and is composed of only a numerical value (S215: YES), the CPU 11 determines whether the numerical value of the acquired data indicates a valid number of sheets to be printed (S216). When the numerical value of the acquired data is equal to or less than the number of printable sheets to be controlled and is not a negative number, the CPU 11 determines that the numerical value of the acquired data indicates a valid number of sheets to be printed. When it is determined that the number of sheets to be printed is valid (S216: YES), the CPU 11 determines the data “3” acquired from the second column as the number of copies (S217), and ends the number-of-copies determination process.

In this case, the CPU 11 generates print data for the determined number of copies “3”, and displays three preview images IM3 on the print setting screen as illustrated in FIG. 9. Therefore, when it is desired to set an individual number of copies for each row, it is preferable to select the first method and perform database printing in which the number of copies for each row can be designated in any column.

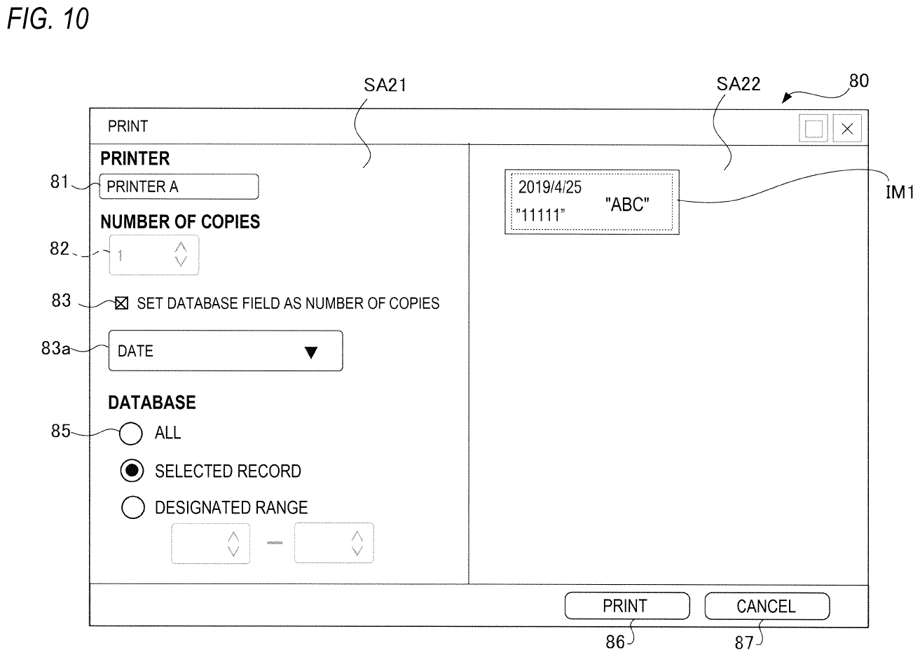

In the print setting screen 80 illustrated in FIG. 10, it is assumed that the print settings are made similarly to the print setting screen 80 of FIG. 9 except that the column of the title of “date” is selected in the column selection field 83a.

In the case of the print setting illustrated in FIG. 10, the CPU 11 acquires data “Apr. 25, 2019” indicated in the column 232a (cell 233m) indicating “date” among the data provided in the row 231b of the database 23 illustrated in FIG. 4. In this case, as illustrated in FIG. 8, although there is data in the cell 233m and the cell 233m is not blank (S214: NO), since the acquired data “Apr. 25, 2019” includes “/(slash)”, the CPU 11 determines that the cell 233m is not composed of only numerical values. If the acquired data is not composed of only numerical values (S215: NO), the CPU 11 determines the number of copies as “1” (S222) since the number of copies cannot be determined, and ends the number-of-copies determination process.

In this case, since the determined number of copies is “1”, the CPU 11 generates one print data and displays one preview image IM1 on the print setting screen 80 as illustrated in FIG. 10. Accordingly, for example, even when the number of copies is erroneously selected in the column selection field 83a, the print application 22 can print one copy of the label of the selected row.

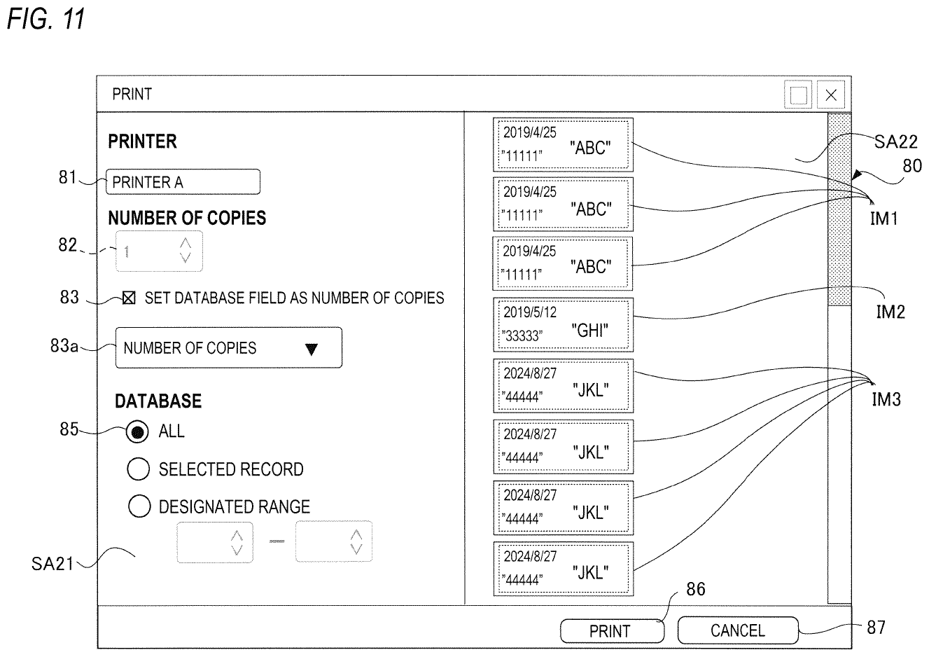

For example, the print setting screen 80 illustrated in FIG. 11 has the same print settings as those in FIG. 9 except that the print target designation field 85 is set to “all”. In this case, the CPU 11 sequentially executes the number-of-copies determination process for all the rows except for the first row of the database 23 and determines the number of copies for each row.

After determining the number of copies for the row 231b of the database 23 illustrated in FIG. 4 as described above, the CPU 11 determines the number of copies for the second row 231c. In this case, the column 232d (cell 2330) of the row 231c is blank. As illustrated in FIG. 8, when determining that the row 231c is blank (S214: YES), the CPU 11 determines the number of copies in the row 231c as “0” since the number of copies is not determined (S223).

When the CPU 11 determines the number of copies for the row 231d of the third row of the database 23 illustrated in FIG. 4, since the column 232d (cell 233p) of the row 231d is not blank (S214: NO) but stores the data “MNO” which is not composed of only the numerical value (S215: NO), the CPU 11 sets “1” as the number of copies (S222) and ends the number-of-copies determination process.

When the data acquired in S211 is a negative number or a numerical value exceeding an upper limit of the number of sheets to be printed that can be handled by the label printer 3 to be controlled, the CPU 11 is not blank (S214: NO), and although it is determined that the acquired data includes only a numerical value (S215: YES), it is determined that the numerical value is not the valid number of sheets to be printed. When the numerical value of the acquired data is not the valid number of sheets to be printed (S216: NO), the CPU 11 determines the number of copies of the row as “1” (S222).

Further, when determining the number of copies for the row 231e of the database 23 illustrated in FIG. 4, if the data “4” stored in the column 232d (cell 233q) of the row 231e is the valid number of sheets to be printed (S214: NO, S215: YES, and S216: YES), the CPU 11 determines the data “4” stored in the cell 233q as the number of copies (S217).

FIG. 11 illustrates the print setting screen 80 in which the number-of-copies designation method is set to the first method, print data is generated for all the rows of the database 23 illustrated in FIG. 4, and preview images thereof are displayed. On the print setting screen 80, in accordance with the determination in the number-of-copies determination process, three preview images IM1 of the label based on the row 231b, one preview image IM2 based on the row 231d, and four preview images IM3 based on the row 231e are displayed. For the row 231c in which the second column is blank, the print data is not generated, and the preview image is not displayed on the print setting screen 80.

In this way, the print application 22 displays the preview images IM1, IM2, and IM3 for the number of copies for each row of the database 23, so that the user can easily confirm whether the appropriate number of copies is set. In addition, the user can easily distinguish between a row to be printed and a row not to be printed in the database 23.

As described above, the print application 22 according to the present embodiment displays the label editing screen 50 on the user IF 13 of the PC 1 and selects one of the text objects disposed in the label region LA of the label editing screen 50 as the first text object. The print application 22 selects one of the columns constituting the designated database 23 as the first column. The print application 22 can execute the first printing process of printing the generated label data in which the text indicated in the data in the first column is written to the first text object for each row of the designated database 23. The print application 22 can further select another column constituting the database 23 as the second column. When the print application 22 performs printing for each row of the designated database 23, the number of copies of the label data based on the row is determined by the data in the second column of the row. As a result, in the print application 22, the number of copies to be printed by the first printing process based on each row is determined by any column, and the degree of freedom in designing the database is increased.

The program having the above configuration displays the editing screen on the user interface of the information processing apparatus, and selects one of the text objects disposed on the editing screen as the first text object. The program selects one of the columns constituting the designated database as the first column. The program can execute the first printing process of printing the generated label data in which the text indicated in the data in the first column is written to the first text object for each row of the designated database. The program can further select another column constituting the database as the second column. When the program performs printing for each row of the designated database, the number of copies of the label data based on the row is determined by the data in the second column of the row. As a result, the number of copies to be printed by the first printing process based on each row is determined by any column, and the degree of freedom in designing the database is increased.

A method and an apparatus for implementing functions of the program, and a computer-readable storage medium storing the program are also novel and useful.

According to the technique disclosed in the present specification, a technique with a high degree of freedom in designing a database when a label is printed by a label printer using the database is implemented.

The present embodiment is merely an example, and does not limit the present invention. Therefore, various improvements and modifications can be naturally made to the present invention without departing from the gist thereof. For example, the print medium of the label printer is not limited to the roll-shaped label paper, and may be fanfold paper or cut label paper.

The form of each display screen illustrated in the accompanying drawings is not limited to the illustrated example, and can be appropriately changed. For example, the arrangement and shape of each button are not limited to the illustrated example. For example, the label may include a graphic in addition to text.

For example, the print target designation field 85 may be omitted and designation of a row may not be received. However, since the print application 22 can designate a row to be printed in the database 23, the user can designate and print any row in the database 23, which is convenient.

For example, the print application 22 may disable the number-of-copies setting field 82 at the time of database printing, may omit the processes of S111 and S131 to S132 of FIG. 7, and may not perform a normal setting of the number of copies. However, the print application 22 displays the number-of-copies setting field 82 in an operable manner so that the normal setting of the number of copies can be performed even during database printing, thereby enabling printing using the database without providing the second column corresponding to the number of copies in the database, and improving the ease of use of the database.

For example, the number-of-copies setting field 82 and the column selection field 83a may be displayed so as to be simultaneously operable, and the selection of the first method and the second method may not be exclusively controlled. However, the print application 22 can avoid confusion in the setting operation of the number of copies by exclusively controlling the selection of the first method and the second method.

For example, when the second column is blank, the print application 22 may determine the number of copies to be one. By treating the blank as one copy, input of data to the second column can be omitted at the time of database design.

For example, when the data in the second column is not a numerical value, the print application 22 may determine the number of copies to be 0 and avoid printing.

For example, in S35 and S43 of FIG. 2, the preview image may not be displayed for the number of copies designated in the database. However, since the print application 22 displays the preview images for the number of copies for each row of the database, the user can easily confirm whether the appropriate number of copies is set.

For example, S35 and S43 of FIG. 2 may be omitted, and the preview image may not be displayed on the print setting screen 80 when the print settings are performed. In this case, the print data generation process may be executed after the print execution instruction is received by operating the print button 86 on the print setting screen 80. In this case, the print execution instruction is an example of the “first print instruction” and the “second print instruction”.

In any flowchart disclosed in the embodiment, an execution order of a plurality of processes in any of a plurality of steps can be freely changed or can be executed in parallel within a range in which no contradiction occurs in a processing content.

The processes disclosed in the embodiment may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a program executable by an information processing apparatus connected to a label printer and having a label editing function, the program causing the information processing apparatus to execute:
a display process of displaying, on a user interface of the information processing apparatus, an editing screen that receives editing of a label and on which at least one text object is able to be disposed;
a designation process of designating a database in a table format consisting of rows and columns;
an object selection process of selecting, as a first text object, one of the text objects disposed on the editing screen;
a first column selection process of selecting, as a first column, one of the columns constituting the database designated in the designation process; and
a second column selection process of selecting, as a second column, one of the columns constituting the database designated in the designation process and different from the first column, wherein
in response to receiving a first print instruction, for each row constituting the database designated by the designation process, the program further causes the information processing apparatus to execute
a generation process of generating label data obtained by writing text indicated in data in the first column selected in the first column selection process to the first text object selected in the object selection process, and
a first printing process of causing the label printer to perform printing based on the label data generated in the generation process for the number of copies indicated in data in the second column selected in the second column selection process.

2. The storage medium according to claim 1, the program further causing the information processing apparatus to execute:
a row setting process of setting a row to be printed among the rows constituting the database designated in the designation process, wherein
in response to receiving the first print instruction, the program further causes the information processing apparatus to execute
the generation process and the first printing process for each row set in the row setting process.

3. The storage medium according to claim 1, the program further causing the information processing apparatus to be able to execute:
a number-of-copies setting process of displaying a number-of-copies object that receives the number of copies on the user interface of the information processing apparatus and setting the number of copies via the number-of-copies object, wherein
in response to receiving a second print instruction, for each row constituting the database designated in the designation process, the program further causes the information processing apparatus to execute
the generation process, and
a second printing process of causing the label printer to perform printing based on the label data generated in the generation process for the number of copies set in the number-of-copies setting process.

4. The storage medium according to claim 3, the program further causing the information processing apparatus to execute:
a method setting process of setting a first method or a second method as a number-of-copies designation method, wherein
if the first method is set in the method setting process, the second column selection process is executable and the first print instruction is acceptable, and the number-of-copies setting process is inexecutable and the second print instruction is unacceptable, and
if the second method is set in the method setting process, the number-of-copies setting process is executable and the second print instruction is acceptable, and the second column selection process is inexecutable and the first print instruction is unacceptable.

5. The storage medium according to claim 1, wherein
in the first printing process, the number of copies in a row in which the second column is blank is set to 0.

6. The storage medium according to claim 1, wherein
in the first printing process, the number of copies in a row in which the second column is blank is set to 1.

7. The storage medium according to claim 1, wherein
in the first printing process, the number of copies in a row in which the second column is data other than a numerical value is set to 0.

8. The storage medium according to claim 1, wherein
in the first printing process, the number of copies in a row in which the second column is data other than a numerical value is set to 1.

9. The storage medium according to claim 1, the program further causing the information processing apparatus to execute:
a determination process of reading a first row of the database designated in the designation process, and determining the read data in each column of the first row as a title of each column, wherein
in the second column selection process,
the second column is selected by displaying a list of the titles of the columns determined in the determination process and selecting one of the displayed titles of the columns, and
the program further causes the information processing apparatus to execute
the generation process and the first printing process for each row excluding the first row of the database designated in the designation process in response to receiving the first print instruction.

10. The storage medium according to claim 1, the program further causing the information processing apparatus to execute:
a preview process of displaying, on the user interface of the information processing apparatus, a preview screen that displays a printing image of the label data generated in the generation process for each row constituting the database designated in the designation process, the preview screen displaying, for each row, the printing image for the number of copies indicated in the data in the second column of the row.

11. The storage medium according to claim 1, wherein
the program further causes the information processing apparatus to
display, on a user interface of the information processing apparatus, the database designated in the designation process and provided on the editing screen,
the program further causes the information processing apparatus to
receive a drag and drop operation of dragging one of the columns constituting the database provided on the editing screen and dropping the same to one of the text objects disposed on the editing screen via the user interface of the information processing apparatus,
in the first column selection process,
the column dragged by the drag and drop operation is selected as the first column, and
in the object selection process,
the text object dropped by the drag and drop operation is selected as the first text object.

12. A control method of an information processing apparatus connected to a label printer, the control method comprising:
a display step of displaying, on a user interface of the information processing apparatus, an editing screen that receives editing of a label and on which at least one text object is able to be disposed;
a designation step of designating a database in a table format consisting of rows and columns;
an object selection step of selecting, as a first text object, one of the text objects disposed on the editing screen;
a first column selection step of selecting, as a first column, one of the columns constituting the database designated in the designation step; and
a second column selection step of selecting, as a second column, one of the columns constituting the database designated in the designation step and different from the first column, wherein
the control method further includes following steps being performed for each row constituting the database designated in the designation step in response to receiving a first print instruction:
a generation step of generating label data obtained by writing text indicated in data to the first column selected in the first column selection step to the first text object selected in the object selection step; and
a first printing step of causing the label printer to perform printing based on the label data generated in the generation step for the number of copies indicated in data in the second column selected in the second column selection step.

13. The control method according to claim 12 further comprising:
a row setting step of setting a row to be printed among the rows constituting the database designated in the designation step via the user interface of the information processing apparatus, wherein
the control method further includes the generation step and the first printing step being performed for each row set in the row setting step in response to receiving the first print instruction.

14. The control method according to claim 12 further comprising:
a number-of-copies setting step of displaying a number-of-copies object that receives the number of copies on the user interface of the information processing apparatus and setting the number of copies via the number-of-copies object, wherein
the control method further includes following steps being performed for each row constituting the database designated in the designation step in response to receiving a second print instruction:
the generation step; and
a second printing step of causing the label printer to perform printing based on the label data generated in the generation step for the number of copies set in the number-of-copies setting step.

15. The control method according to claim 14 further comprising:
a method setting step of setting a first method or a second method as a number-of-copies designation method, wherein
if the first method is set in the method setting step, the second column selection step is executable and the first print instruction is acceptable, and the number-of-copies setting step is inexecutable and the second print instruction is unacceptable, and
if the second method is set in the method setting step, the number-of-copies setting step is executable and the second print instruction is acceptable, and the second column selection step is inexecutable and the first print instruction is unacceptable.

16. The control method according to claim 12 further comprising:
a determination step of reading a first row of the database designated in the designation step and determining the read data in each column of the first row as a title of each column, wherein
in the second column selection step,
a list of the titles of the columns determined in the determining step are displayed and the second column is selected by selecting one of the displayed titles of the columns, and
the control method further includes the generation step and the first printing step being performed for each row excluding the first row of the database designated in the designation step in response to receiving the first print instruction.

17. The control method according to claim 12, further comprising:
a preview step of displaying, on a user interface of the information processing apparatus, a preview screen that displays a printing image of the label data generated in the generation step for each row constituting the database designated in the designation step, the preview screen displaying, for each row, the printing image for the number of copies indicated in the data in the second column of the row.

18. The control method according to claim 12, wherein
the database designated in the designation step and provided on the editing screen is configured to be displayed on the user interface of the information processing apparatus,
a drag and drop operation of dragging one of the columns constituting the database provided on the editing screen and dropping the same to one of the text objects disposed on the editing screen via the user interface of the information processing apparatus is configured to be received,
in the first column selection step,
the column dragged by the drag and drop operation is selected as the first column, and in the object selection step,
the text object dropped by the drag and drop operation is selected as the first text object.
